(19) United States
(12) Patent Application Publication
(10) Pub. No.: US 2019/0119604 A1
(43) Pub. Date: Apr. 25, 2019

(54) LUBRICANT COMPOSITION FOR SHOCK ABSORBERS, METHOD FOR PRODUCING SAME, DAMPING METHOD AND SHOCK ABSORBER

(71) Applicant: IDEMITSU KOSAN CO., LTD., Chiyoda-ku (JP)

(72) Inventors: Shuichi SAKANOUE, Chiba-shi (JP); Tatsuya HAMACHI, Chiba-shi (JP)

(73) Assignee: IDEMITSU KOSAN CO., LTD., Chiyoda-ku (JP)

(21) Appl. No.: 16/094,693

(22) PCT Filed: Apr. 5, 2017
(86) PCT No.: PCT/JP2017/014211

§ 371 Date: Oct. 18, 2018

(30) Foreign Application Priority Data
Apr. 25, 2016 (JP) 2016-087393

(51) Int. Cl. C10M 171/04; C10M 169/04; F16F 9/32

(52) U.S. Cl. CPC C10M 171/04; C10M 169/041; F16F 9/32; C10N 2240/06; C10N 2220/021; C10N 2220/028; C10N 2230/02

(57) ABSTRACT

Provided are a lubricating oil composition for shock absorber, containing a base oil and a comb polymer having a mass average molecular weight of 5×10⁴ or more and 1×10⁶ or less, which has a high viscosity index and provides a shock absorber capable of keeping a damping force thereof substantially constant at any temperature and exhibiting excellent damping force characteristics; a method of producing the lubricating oil composition for shock absorber; a damping method; and a shock absorber.

### TECHNICAL FIELD

The present invention relates to a lubricating oil composition for shock absorber and a method of producing the same and also to a damping method and a shock absorber.

### BACKGROUND ART

In order to relieve vibrations due to roughness of a road surface, sways generated on the occasion of sudden acceleration or sudden braking, or the like, suspensions having a shock absorber installed therein are used for bodies of two-wheeled vehicles or four-wheeled vehicles, etc. The structure of the shock absorber is based on a cylindrical structure utilizing flow resistance of an oil, and specifically, a hydraulic piston provided with a small hole is used.

A damping force of the shock absorber varies with properties of a shock absorber oil to be filled, and in particular, it is determined by its kinematic viscosity. In the case of two-wheeled vehicles, an oil temperature in the shock absorber especially in a rear wheel is liable to rise, and the temperature changes from normal temperature to about 100° C. In consequence, in order to keep the damping force constant, it is required that even when the temperature varies, the change of kinematic viscosity of the shock absorber oil is small, namely, a viscosity index of the shock absorber oil is high.

As an attempt to improve the viscosity index of the shock absorber oil, for example, PTL 1 discloses a shock absorber oil composition using, as a base oil, a hydroreformed mineral oil and/or a synthetic oil and using, as a viscosity index improver, a specified amount of a high-molecular weight poly(meth)acrylate or α-olefin copolymer.

### CITATION LIST

### Patent Literature

PTL 1: JP 2005-314609 A

### SUMMARY OF INVENTION

### Technical Problem

In recent years, sophistication of vehicles is increasing, and a burden on the shock absorber due to acceleration, speed reduction, etc. has become larger. For this reason, in the shock absorber oil composition disclosed in PTL 1, the viscosity index improving effect is not satisfactory yet, and more improvements are demanded.

In view of the foregoing circumstances, the present invention is aimed to provide a lubricating oil composition for shock absorber, which has a high viscosity index and provides a shock absorber capable of keeping a damping force thereof substantially constant at any temperature and exhibiting excellent damping force characteristics, and a production method of the same and also to provide a damping method and a shock absorber.

### Solution to Problem

The present inventors have found that a lubricating oil composition containing a polymer solution containing a high-molecular weight resin component together with a base oil is able to solve the aforementioned problem, thereby leading to accomplishment of the present invention.

Specifically, the present invention provides the following [1] to [4].

[1] A lubricating oil composition for shock absorber, containing a base oil and a comb polymer having a mass average molecular weight of 5×10⁴ or more and 1×10⁶ or less.
[2] A shock absorber including the lubricating oil composition for shock absorber as set forth in [1].
[3] A method of damping sways or vibrations, including using the lubricating oil composition for shock absorber as set forth in [1].
[4] A method of producing a lubricating oil composition for shock absorber, including a step of blending a base oil with a comb polymer having a mass average molecular weight of 5×10⁴ or more and 1×10⁶ or less.

### Advantageous Effects of Invention

The lubricating oil composition for shock absorber of the present invention has a high viscosity index and provides a shock absorber capable of keeping a clamping force thereof substantially constant at any temperature and exhibiting excellent damping force characteristics.

### DESCRIPTION OF EMBODIMENTS

In this specification, a kinematic viscosity and a viscosity index at a predetermined temperature mean values as measured in conformity with JIS K2283:2000. In addition, the numerical values of “or more” and “or less” regarding the numerical value ranges are numerical values capable of being arbitrarily combined.

### [Lubricating Oil Composition for Shock Absorber]

The lubricating oil composition for shock absorber of the present invention (hereinafter sometimes referred to simply as “lubricating oil composition”) contains a base oil and a comb polymer having a mass average molecular weight of 5×10⁴ or more and 1×10⁶ or less.

The lubricating oil composition according to one embodiment of the present invention may further contain other additive for lubricating oil within a range where the effects of the present invention are not impaired.

In the present invention, it is preferred that the aforementioned comb polymer is blended as a polymer solution diluted with a diluent as mentioned later, in the base oil. In that case, in the lubricating oil composition according to one embodiment of the present invention, a total content of the base oil and the aforementioned polymer solution is preferably 70.01% by mass or more, more preferably 80.01% by mass or more, and still more preferably 90.01% by mass or more, and it is typically 100% by mass or less, preferably 99.9% by mass or less, and more preferably 99% by mass or less, on the basis of the whole amount (100% by mass) of the lubricating oil composition. When the blending amount of the base oil and the aforementioned polymer solution is 70.01% by mass or more, a satisfactory viscosity index improving effect in the lubricating oil composition is obtained.

Details of the respective components to be contained in the lubricating oil composition for shock absorber of the present invention are hereunder described.

### <Base Oil>

The base oil that is used in the present invention may be either a mineral oil or a synthetic oil and may also be a mixed oil composed of a combination of two or more selected from a mineral oil and a synthetic oil.

Examples of the mineral oil include atmospheric residues obtained by atmospheric distillation of a crude oil, such as a paraffinic mineral oil, an intermediate mineral oil, and a naphthenic mineral oil; distillate oils obtained by vacuum distillation of these atmospheric residues; mineral oils obtained by subjecting the distillate oil to at least one purification process, such as solvent deasphalting, solvent extraction, hydrocracking, solvent dewaxing, catalytic dewaxing, and hydrorefining; and mineral oil waxes obtained by isomerizing a wax produced by the Fischer-Tropsch process (gas-to-liquid waxes), etc.

These mineral oils may be used alone or may be used in combination of two or more thereof.

Examples of the synthetic oil include poly-α-olefins, such as an α-olefin homopolymer and an α-olefin copolymer (for example, a copolymer of an α-olefin having a carbon number of 8 to 14, such as an ethylene-α-olefin copolymer); isoparaffins; various esters, such as a polyol ester, a dibasic acid ester (for example, ditridecyl glutarate), a tribasic acid ester (for example, 2-ethylhexyl trimellitate), and a phosphoric acid ester; various ethers, such as polyphenyl ether; polyalkylene glycols; alkylbenzenes; and alkylnaphthalenes.

These synthetic oils may be used alone or may be used in combination of two or more thereof.

The base oil that is used in the present invention is suitably a synthetic oil from the viewpoint that an effect for enhancing the viscosity index at the time of adding the comb polymer is high.

Among the aforementioned synthetic oils, the synthetic oil that is used in the present invention is preferably at least one synthetic oil selected from poly-α-olefins, various esters, and polyalkylene glycols, and more preferably a poly-α-olefin.

A kinematic viscosity at 40° C. of the base oil is preferably 1 mm²/s or more and 8 mm²/s or less, more preferably 2 mm²/s or more and 7 mm²/s or less, and still more preferably 2 mm²/s or more and 6 mm²/s or less.

When the kinematic viscosity at 40° C. is 1 mm²/s or more and 8 mm²/s or less, it is easy to control the kinematic viscosity of the lubricating oil composition containing the aforementioned polymer to the desired range, and hence, such is preferred.

A kinematic viscosity at 100° C. of the base oil is preferably 0.5 mm²/s or more and 5 mm²/s or less, more preferably 1.0 mm²/s or more and 4.75 mm²/s or less, and still more preferably 1.5 mm²/s or more and 4.5 mm²/s or less.

A viscosity index of the base oil is preferably GO or more, more preferably 80 or more, and still more preferably 90 or more.

In the lubricating oil composition according to one embodiment of the present invention, the content of the base oil is preferably 60% by mass or more, more preferably 70% by mass or more, still more preferably 75% by mass, and especially preferably 80% by mass or more, and it is preferably 99.99% by mass or less, more preferably 99.95% by mass or less, and still more preferably 99.90% by mass or less, on the basis of the whole amount (100% by mass) of the lubricating oil composition.

### <Comb Polymer>

The lubricating oil composition for shock absorber of the present invention contains a comb polymer having a mass average molecular weight of 5×10⁴ or more and 1×10⁶ or less.

In one embodiment of the present invention, a mass average molecular weight (Mw) of the comb polymer is 5×10⁴ or more and 1×10⁶ or less. When Mw is less than 5×10⁴, in the case of adding to the base oil, a satisfactory viscosity index improving effect in the lubricating oil composition is not obtained, whereas when Mw is more than 1×10⁶, solubility in the base oil is worsened, or the viscosity of the lubricating oil composition becomes high more than necessary.

Mw of the comb polymer is preferably 8×10⁴ or more and 1×10⁶ or less, more preferably 1×10⁵ or more and 1×10⁶ or less, and still more preferably 3×10⁵ or more and 8×10⁵ or less.

The “comb polymer” as referred to in the present invention refers to a polymer having a structure having a large number of trigeminal branch points from which a high-molecular weight side chain comes out in a main chain thereof.

The comb polymer having such a structure is preferably a polymer having at least a structural unit (X1) derived from a macromonomer (x1). This structural unit (X1) is corresponding to the aforementioned “high-molecular weight side chain”.

In the present invention, the aforementioned “macromonomer” means a high-molecular weight monomer having a polymerizable functional group and is preferably a high-molecular weight monomer having a polymerizable functional group in an end thereof.

A number average molecular weight (Mn) of the macromonomer (x1) is preferably 200 or more, more preferably 300 or more, still more preferably 400 or more, and yet still more preferably 500 or more, and it is preferably 200,000 or less, more preferably 100,000 or less, still more preferably 50,000 or less, and yet still more preferably 20,000 or less.

Examples of the polymerizable functional group which the macromonomer (x1) has include an acryloyl group (CH₂═CH—COO—), a methacryloyl group (CH₂═CCH₃—COO—), an ethenyl group (CH₂═CH—), a vinyl ether group (CH₂═CH—O—), an allyl group (CH₂═CH—CH₂—), an allyl ether group (CH₂═CH—CH₂—O—), a group represented by CH₂═CH—CONH—, and a group represented by CH₂═CCH₃—CONH—.

The macromonomer (x1) may also have, for example, at least one selected from repeating units represented by the following general formulae (i) to (iii) in addition to the aforementioned polymerizable functional groups.

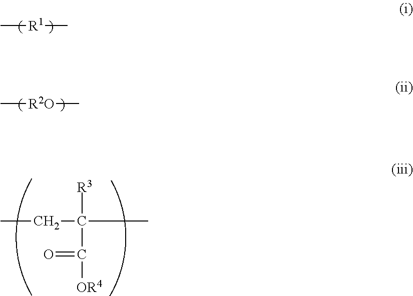

In the general formula (i), R¹ represents a linear or branched alkylene group having a carbon number of 1 to 10, and specifically, examples thereof include a methylene group, an ethylene group, a 1,2-propylene group, a 1,3-propylene group, a 1,2-butylene group, a 1,3-butylene group, a 1,4-butylene group, a pentylene group, a hexylene group, a heptylene group, an octylene group, a nonylene group, a decylene group, an isopropylene group, an isobutylene group, and a 2-ethylhexylene group.

In the general formula (ii), R² represents a linear or branched alkylene group having a carbon number of 2 to 4, and specifically, examples thereof include an ethylene group, a 1,2-propylene group, a 1,3-propylene group, a 1,2-butylene group, a 1,3-butylene group, and a 1,4-butylene group.

In the general formula R³ represents a hydrogen atom or a methyl group.

R⁴ represents a linear or branched alkyl group having a carbon number of 1 to 10, and specifically, examples thereof include a methyl group, an ethyl group, a n-propyl group, a n-butyl group, a n-pentyl group, a n-hexyl group, a n-heptyl group, a n-octyl group, a n-nonyl group, a n-decyl group, an isopropyl group, an isobutyl group, a sec-butyl group, a t-butyl group, an isopentyl group, a t-pentyl group, an isohexyl group, a t-hexyl group, an isoheptyl group, a t-heptyl group, a 2-ethylhexyl group, an isooctyl group, an isononyl group, and an isodecyl group.

In the case where plural repeating units are present as the repeating unit represented by any one of the general formulae (i) to R¹'s, R²'s, R³'s, or R⁴'s, which the plural repeating units have, may be the same or different.

In the case where the macromonomer (x1) is a copolymer having two or more repeating units selected from the general formulae (i) to (iii), the mode of the copolymerization may be a block copolymer or may be a random copolymer.

In one embodiment of the present invention, the comb polymer may be a homopolymer composed of only the structural unit (X1) derived from one kind of the macromonomer (x1) or may be a copolymer containing the structural unit (X1) derived from two or more kinds of the macromonomer (x1).

In addition, in one embodiment of the present invention, the comb polymer may also be a copolymer containing a structural unit (X2) derived from other monomer (x2) than the macromonomer (x1) as well as the structural unit derived from the macromonomer (x1).

As a specific structure of such a comb polymer, a copolymer having a side chain containing the structural unit (X1) derived from the macromonomer (x1) relative to the main chain containing the structural unit (X2) derived from the monomer (x2) is preferred.

Examples of the monomer (x2) include a monomer (x2-a) represented by the following general formula (a1), an alkyl (meth)acrylate (x2-b), a nitrogen atom-containing vinyl monomer (x2-c), a hydroxy group-containing vinyl monomer (x2-d), a phosphorus atom-containing monomer (x2-e), an aliphatic hydrocarbon-based vinyl monomer (x2 an alicyclic hydrocarbon-based vinyl monomer (x2-g), a vinyl ester (x2-h), a vinyl ether (x2-i), a vinyl ketone (x2-j), an epoxy group-containing vinyl monomer (x2-k), a halogen element-containing vinyl monomer (x2-l), an ester of unsaturated polycarboxylic acid (x2-m), a (di)alkyl fumarate (x2-n), and a (di)alkyl maleate (x2-o).

As the monomer (x2), the phosphorus atom-containing monomer (x2-e) and a monomer other than an aromatic hydrocarbon-based vinyl monomer are preferred.

The wording “alkyl (meth)acrylate” as referred to in this specification is used as a terminology including both an “alkyl acrylate” and an “alkyl methacrylate”, and the same is applicable to other analogous terminologies or the same expressions.

(Monomer (x2-a) Represented by the Following General Formula (a1))

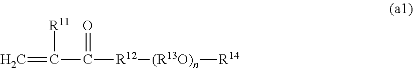

In the general formula (a1), R¹¹ represents a hydrogen atom or a methyl group.

R¹² represents a single bond, a linear or branched alkylene group having a carbon number of 1 to 10, —O—, or —NH—.

R¹³ represents a linear or branched alkylene group having a carbon number of 2 to 4. In addition, n represents an integer of 1 or more (preferably an integer of 1 to 20, and more preferably an integer of 1 to 5). In the case where n is an integer of 2 or more, plural R¹³'s may be the same as or different from each other, and furthermore, the (R¹³O)ₙ moiety may also be either a random bond or a block bond.

R¹⁴ represents a linear or branched alkyl group having a carbon number of 1 to 60 (preferably 10 to 50, and more preferably 20 to 40).

Specific groups of the aforementioned “linear or branched alkylene group having a carbon number of 1 to 10”, “linear or branched alkylene group having a carbon number of 2 to 4”, and “linear or branched alkyl group having a carbon number of 1 to 60” include the same groups as those exemplified in the descriptions regarding the aforementioned general formulae (i) to (iii).

(Alkyl (Meth)Acrylate (x2-b))

Examples of the alkyl (meth)acrylate (x2-b) include methyl (meth)acrylate, ethyl (meth)acrylate, n-propyl (meth)acrylate, isopropyl (meth)acrylate, n-butyl (meth)acrylate, t-butyl (meth)acrylate, pentyl (meth)acrylate, hexyl (meth)acrylate, 2-ethylhexyl (meth)acrylate, heptyl (meth)acrylate, 2-t-butylheptyl (meth)acrylate, octyl (meth)acrylate, and 3-isopropylheptyl (meth)acrylate.

The carbon number of the alkyl group which the alkyl (meth)acrylate (x2-b) has is preferably 1 to 30, more preferably 1 to 26, and still more preferably 1 to 10.

(Nitrogen Atom-Containing Vinyl Monomer (x2-c))

Examples of the nitrogen atom-containing vinyl monomer (x2-c) include an amide group-containing vinyl monomer (x2-c1), a nitro group-containing monomer (x2-c2), a primary amino group-containing vinyl monomer (x2-c3), a secondary amino group-containing vinyl monomer (x2-c4), a tertiary amino group-containing vinyl monomer (x2-c5), and a nitrile group-containing vinyl monomer (x2-c6).

Examples of the amide group-containing vinyl monomer (x2-c1) include (meth)acrylamide; monoalkylamino (meth)acrylamides, such as N-methyl (meth)acrylamide, N-ethyl (meth)acrylamide, N-isopropyl (meth)acrylamide, and N-n- or isobutyl (meth)acrylamide; monoalkylaminoalkyl (meth)acrylamides, such as N-methylaminoethyl (meth)acrylamide, N-ethylaminoethyl (meth)acrylamide, N-isopropylamino-n-butyl (meth)acrylamide, and N-n- or isobutylamino-n-butyl (meth)acrylamide; di alkylamino (meth)acrylamides, such as N,N-dimethyl (meth)acrylamide, N,N-diethyl (meth)acrylamide, N,N-diisopropyl (meth)acrylamide, and N,N-di-n-butyl (meth)acrylamide; dialkylaminoalkyl (meth)acrylamides, such as N,N-dimethylaminoethyl (meth)acrylamide, N,N-diethylaminoethyl (meth)acrylamide, N,N-dimethylaminopropyl (meth)acrylamide, and N,N-di-n-butylaminobutyl (meth)acrylamide; and N-vinylcarboxylic acid amides, such as N-vinylformamide, N-vinylacetamide, N-vinyl-n- or isopropionylamide, and N-vinylhydroxyacetamide.

Examples of the nitro group-containing monomer (x2-c2) include 4-nitrostyrene.

Examples of the primary amino group-containing vinyl monomer (x2-c3) include alkenylamines having an alkenyl group having a carbon number of 3 to 6, such as (meth)allylamine and crotylamine; and aminoalkyl (meth)acrylates having an alkyl group having a carbon number of 2 to 6, such as aminoethyl (meth)acrylate.

Examples of the secondary amino group-containing vinyl monomer (x2-c4) include mono alkylaminoalkyl (meth)acrylates, such as t-butylaminoethyl (meth)acrylate and methylaminoethyl (meth)acrylate; and dialkenylamines having a carbon number of 6 to 12, such as di(meth)allylamine.

Examples of the tertiary amino group-containing vinyl monomer (x2-c5) include dialkylaminoalkyl (meth)acrylates, such as dimethylaminoethyl (meth)acrylate and diethylaminoethyl (meth)acrylate; alicyclic (meth)acrylates having a nitrogen atom, such as morpholinoethyl (meth)acrylate; aromatic vinyl-based monomers, such as diphenylamine (meth)acrylamide, N,N-dimethylaminostyrene, 4-vinylpyridine, 2-vinylpyridine, N-vinylpyrrole, N-vinylpyrrolidone, and N-vinylthiopyrrolidone; and hydrochlorides, sulfates, phosphates, or lower alkyl (carbon number: 1 to 8) monocarboxylic acid (e.g., acetic acid and propionic acid) salts thereof.

Examples of the nitrile group-containing vinyl monomer (x2-c6) include (meth)acrylonitrile.

(Hydroxy Group-Containing Vinyl Monomer (x2-d))

Examples of the hydroxy group-containing vinyl monomer (x2-d) include a hydroxy group-containing vinyl monomer (x2-d1) and a polyoxyalkylene chain-containing vinyl monomer (x2-d2).

Examples of the hydroxy group-containing vinyl monomer (x2-d1) include hydroxy group-containing aromatic vinyl monomers, such as p-hydroxystyrene; hydroxyalkyl (meth)acrylates having an alkyl group having a carbon number of 2 to 6, such as 2-hydroxyethyl (meth)acrylate and 2- or 3-hydroxypropyl (meth)acrylate; mono- or di-hydroxyalkyl-substituted (meth)acrylamides having an alkyl group having a carbon number of 1 to 4, such as N,N-dihydroxymethyl (meth)acrylamide, N,N-dihydroxypropyl (meth)acrylamide, and N,N-di-2-hydroxybutyl (meth)acrylamide; vinyl alcohol; alkenols having a carbon number of 3 to 12, such as (meth)allyl alcohol, crotyl alcohol, isocrotyl alcohol, 1-octenol, and 1-undecenol; alkene monools or alkene diols each having a carbon number of 4 to 12, such as 1-buten-3-ol, 2-buten-1-ol, and 2-butene-1,4-diol; hydroxyalkyl alkenyl ethers having an alkyl group having a carbon number of 1 to 6 and an alkenyl group having a carbon number of 3 to 10, such as 2-hydroxyethyl propenyl ether; and alkenyl ethers or (meth)acrylates of a polyhydric alcohol, such as glycerin, pentaerythritol, sorbitol, sorbitan, diglycerin, a sugar, and sucrose.

Examples of the polyoxyalkylene chain-containing vinyl monomer (x2-d2) include a polyoxyalkylene glycol (carbon number of the alkylene group: 2 to 4, degree of polymerization: 2 to 50), a polyoxyalkylene polyol (polyoxyalkylene ether of the aforementioned polyhydric alcohol (carbon number of the alkylene group: 2 to 4, degree of polymerization: 2 to 100)), a mono(meth)acrylate of an alkyl (carbon number: 1 to 4) ether of a polyoxyalkylene glycol or polyoxyalkylene polyol [e.g., polyethylene glycol (number average molecular weight (Mn): 100 to 300) mono(meth)acrylate, polypropylene glycol (Mn: 130 to 500) mono(meth)acrylate, methoxypolyethylene glycol (Mn: 110 to 310) (meth)acrylate, lauryl alcohol ethylene oxide adduct (2 to 30 mols) (meth)acrylate, and mono(meth)acrylic acid polyoxyethylene (Mn: 150 to 230) sorbitan].

(Phosphorus Atom-Containing Monomer (x2-e))

Examples of the phosphorus atom-containing monomer (x2-e) include a phosphoric acid ester group-containing monomer (x2-e1) and a phosphono group-containing monomer (x2-e2).

Examples of the phosphoric acid ester group-containing monomer (x2-e1) include (meth)acryloyloxyalkyl phosphates having an alkyl group having a carbon number of 2 to 4, such as (meth)acryloyloxyethyl phosphate and (meth)acryloyloxyisopropyl phosphate; and alkenyl phosphates having an alkenyl group having a carbon number of 2 to 12, such as vinyl phosphate, allyl phosphate, propenyl phosphate, isopropenyl phosphate, butenyl phosphate, pentenyl phosphate, octenyl phosphate, decenyl phosphate, and dodecenyl phosphate.

Examples of the phosphono group-containing monomer (x2-e2) include (meth)acryloyloxyalkyl phosphonates having an alkyl group having a carbon number of 2 to 4, such as (meth)acryloyloxyethyl phosphonate; and alkenyl phosphonates having an alkenyl group having a carbon number of 2 to 12, such as vinyl phosphonate, allyl phosphonate, and octenyl phosphonate.

(Aliphatic Hydrocarbon-Based Vinyl Monomer (x2-f))

Examples of the aliphatic hydrocarbon-based vinyl monomer (x2-f) include alkenes having a carbon number of 2 to 20, such as ethylene, propylene, butene, isobutylene, pentene, heptene, diisobutylene, octene, dodecene, and octadecene; and alkadienes having a carbon number of 4 to 12, such as butadiene, isoprene, 1,4-pentadiene, 1,6-heptadiene, and 1,7-octadiene.

The carbon number of the aliphatic hydrocarbon-based vinyl monomer (x2-f) is preferably 2 to 30, more preferably 2 to 20, and still more preferably 2 to 12.

(Alicyclic Hydrocarbon-Based Vinyl Monomer (x2-g))

Examples of the alicyclic hydrocarbon-based vinyl monomer (x2-g) include cyclohexene, (di)cyclopentadiene, pinene, limonene, vinylcyclohexene, and ethylidene bicycloheptene.

The carbon number of the alicyclic hydrocarbon-based vinyl monomer (x2-g) is preferably 3 to 30, more preferably 3 to 20, and still more preferably 3 to 12.

(Vinyl Ester (x2-h))

Examples of the vinyl ester (x2-h) include vinyl esters of a saturated fatty acid having a carbon number of 2 to 12, such as vinyl acetate, vinyl propionate, vinyl butyrate, and vinyl octanoate.

(Vinyl Ether (x2-i))

Examples of the vinyl ether (x2-i) include alkyl vinyl ethers having a carbon number of 1 to 12, such as methyl vinyl ether, ethyl vinyl ether, propyl vinyl ether, butyl vinyl ether, and 2-ethylhexyl vinyl ether; aryl vinyl ethers having a carbon number of 6 to 12, such as phenyl vinyl ether; and alkoxyalkyl vinyl ethers having a carbon number of 1 to 12, such as vinyl-2-methoxyethyl ether and vinyl-2-butoxyethyl ether.

(Vinyl Ketone (x2-j))

Examples of the vinyl ketone (x2-j) include alkyl vinyl ketones having a carbon number of 1 to 8, such as methyl vinyl ketone and ethyl vinyl ketone; and aryl vinyl ketones having a carbon number of 6 to 12, such as phenyl vinyl ketone.

(Epoxy Group-Containing Vinyl Monomer (x2-k))

Examples of the epoxy group-containing vinyl monomer (x2-k) include glycidyl (meth)acrylate and glycidyl (meth)allyl ether.

(Halogen Element-Containing Vinyl Monomer (x2-1))

Examples of the halogen element-containing vinyl monomer (x2-1) include vinyl chloride, vinyl bromide, vinylidene chloride, and (meth)allyl chloride; and halogenated styrenes (e.g., dichlorostyrene).

(Ester of Unsaturated Polycarboxylic Acid (x2-m))

Examples of the ester of unsaturated polycarboxylic acid (x2-m) include an alkyl ester of an unsaturated polycarboxylic acid, a cycloalkyl ester of an unsaturated polycarboxylic acid, and an aralkyl ester of an unsaturated polycarboxylic acid; and examples of the unsaturated carboxylic acid include maleic acid, fumaric acid, and itaconic acid.

((Di)Alkyl Fumarate (x2-n))

Examples of the (di)alkyl fumarate (x2-n) include monomethyl fumarate, dimethyl fumarate, monoethyl fumarate, diethyl fumarate, methylethyl fumarate, monobutyl fumarate, dibutyl fumarate, dipentyl fumarate, and dihexyl fumarate.

((Di)Alkyl Maleate (x2-o))

Examples of the (di)alkyl maleate (2x-o) include monomethyl maleate, dimethyl maleate, monoethyl maleate, diethyl maleate, methylethyl maleate, monobutyl maleate, and dibutyl maleate.

As for the comb polymer in the present invention, in the case of adding as a viscosity index improver to the base oil to produce a lubricating oil composition, the comb polymer is preferably used as a polymer solution diluted with a diluent.

Examples of the aforementioned diluent include aliphatic solvents [aliphatic hydrocarbons having a carbon number of 6 to 18 (such as hexane, heptane, cyclohexane, octane, decalin, and kerosene)]; aromatic solvents [such as aromatic solvents having a carbon number of 7 to 15 {such as aromatic mixed solvents of toluene, xylene, ethylbenzene, and an aromatic mixed solvent having a carbon number of 9 (e.g., a mixture of trimethyl benzene and ethyl toluene)} and an aromatic mixed solvent having a carbon number of 10 to 11]; mineral oils [for example, solvent-refined oil, paraffinic oil, high viscosity index oil containing an isoparaffin and/or resulting from hydrocracking, and naphthenic oil]; and synthetic lubricating oils [such as hydrocarbon-based synthetic lubricating oils (e.g., poly-α-olefin-based synthetic lubricating oils) and ester-based synthetic lubricating oils]. Of these, mineral oils are preferred.

In the present invention, a concentration of the comb polymer in the polymer solution is preferably 5% by mass or more and 50% by mass or less, more preferably 10% by mass or more and 40% by mass or less, and still more preferably 15% by mass or more and 30% by mass or less.

A blending amount of the aforementioned polymer solution in the base oil is preferably 5% by mass or more and 40% by mass or less, more preferably 10% by mass or more and 30% by mass or less, and still more preferably 15% by mass or more and 25% by mass or less on the basis of the whole amount of the lubricating oil composition after blending.

In the lubricating oil composition after blending, the content of the resin component of the comb polymer is preferably 1% by mass or more and 10% by mass or less, more preferably 1.5% by mass or more and 8% by mass or less, and still more preferably 2% by mass or more and 5% by mass or less. When the content of the resin component of the comb polymer is 1% by mass or more and 10% by mass or less, in the case of adding to the base oil, a satisfactory viscosity index improving effect in the lubricating oil composition can be obtained.

### <Other Additive for Lubricating Oil>

The lubricating oil composition according to one embodiment of the present invention may further contain an additive for lubricating oil other than the base oil and the comb polymer within a range where the effects of the present invention are not impaired.

Examples of such an additive for lubricating oil include a viscosity index improver, a pour-point depressant, an ash-free detergent dispersant, a metal-based detergent, an antioxidant, an extreme pressure agent, an anti-wear agent, a rust inhibitor, and a metal deactivator.

These various additives for lubricating oil may be used alone or may be used in combination of two or more thereof.

In the case of using each of these additives for lubricating oil, though its content can be properly regulated within a range where the effects of the present invention are not impaired, it is typically 0.001% by mass or more and 10% by mass or less, preferably 0.005% by mass or more and 8% by mass or less, and more preferably 0.01% by mass or more and 5% by mass or less on the basis of the whole amount (100% by mass) of the lubricating oil composition.

In the lubricating oil composition according to one embodiment of the present invention, a total content in the case of using these additives for lubricating oil is preferably 0.001% by mass or more and 35% by mass or less, more preferably 0.001% by mass or more and 20% by mass or less, and still more preferably 0.001% by mass or more and 10% by mass or less on the basis of the whole amount (100% by mass) of the lubricating oil composition.

### (Viscosity Index Improver)

The lubricating oil composition according to one embodiment of the present invention may further contain other viscosity index improver that is not corresponding to the aforementioned comb polymer within a range where the effects of the invention are not impaired.

Examples of the aforementioned other viscosity index improver include polymers, such as a non-dispersion type polymethacrylate, a dispersion type polymethacrylate, an olefin-based copolymer (for example, an ethyl-propylene copolymer), a dispersion type olefin-based copolymer, and a styrene-based copolymer (for example, a styrene-butadiene copolymer and a styrene-isoprene copolymer).

### (Pour-Point Depressant)

Examples of the pour-point depressant include an ethylene-vinyl acetate copolymer, a condensate of a chlorinated paraffin and naphthalene, a condensate of a chlorinated paraffin and phenol, a polymethacrylate, and a polyalkylstyrene. Of these, a polymethacrylate is preferably used.

A mass average molecular weight (Mw) of such a pour-point depressant is typically 50,000 to 150,000.

### (Ash-Free Detergent Dispersant)

Examples of the ash-free detergent dispersant include imides, such as a succinimide and a boron-containing succinimide, benzylamines, boron-containing benzylamines, and divalent carboxylic acid amides represented by succinic acid. Of these, a succinimide is preferred.

Examples of the succinimide include monoimides or bisimides between a succinic acid having a polyalkenyl group having a number average molecular weight of 300 to 4,000, such as a polybutenyl group, and a polyethylene polyamine, such as ethylene diamine, diethylene triamine, triethylene tetramine, tetraethylene pentamine, and pentamethylene hexamine, or boric acid-modified products thereof; and Mannich reaction products having a polyalkenyl group among phenol, formaldehyde, and polyethylene polyamine.

### (Metal-Based Detergent)

Examples of the metal-based detergent include a neutral metal sulfonate, a neutral metal phenate, a neutral metal salicylate, a neutral metal phosphonate, a basic metal sulfonate, a basic metal phenate, a basic metal salicylate, a basic metal phosphonate, an overbased metal sulfonate, an overbased metal phenate, an overbased metal salicylate, and an overbased metal phosphonate.

### (Antioxidant)

As the antioxidant, an arbitrary antioxidant can be properly selected and used among known antioxidants which have hitherto been used as an antioxidant for lubricating oil. Examples thereof include an amine-based antioxidant, a phenol-based antioxidant, a molybdenum-based antioxidant, a sulfur-based antioxidant, and a phosphorus-based antioxidant.

These antioxidants may be used alone or may be used in combination of two or more thereof.

Examples of the amine-based antioxidant include diphenylamine-based antioxidants, such as diphenylamine and an alkylated diphenylamine having an alkyl group having a carbon number of 3 to 20; and naphthylamine-based antioxidants, such as α-naphthylamine, phenyl-α-naphthylamine, and a substituted phenyl-α-naphthylamine having an alkyl group having a carbon number of 3 to 20.

Examples of the phenol-based antioxidant include monophenol-based antioxidants, such as 2,6-di-tert-butylphenol, 2,6-di-tert-butyl-4-methylphenol, 2,6-di-tert-butyl-4-ethylphenol, isooctyl-3-(3,5-di-tert-butyl-4-hydroxyphenyl) propionate, and octadecyl-3-(3,5-di-tert-butyl-4-hydroxyphenyl) propionate; diphenol-based antioxidants, such as 4,4′-methylenebis(2,6-di-tert-butylphenol) and 2,2′-methylenebis(4-ethyl-6-tert-butylphenol); and hindered phenol-based antioxidants.

Examples of the molybdenum-based antioxidant include a molybdenum amine complex resulting through a reaction of molybdenum trioxide and/or molybdic acid and an amine compound.

Examples of the sulfur-based antioxidant include dilauryl-3,3′-thio dipropionate.

Examples of the phosphorus-based antioxidant include a phosphite.

### (Extreme Pressure Agent and Anti-Wear Agent)

Examples of the extreme pressure agent and the anti-wear agent include sulfur-based compounds, such as a sulfide, a sulfoxide, a sulfone, and a thiophosphinate; halogen-based compounds, such as a chlorinated hydrocarbon; and organometallic compounds, such as zinc dithiophosphate (ZnDTP), zinc dithiocarbamate (ZnDTC), sulfurized oxymolybdenum organophosphorodithioate (MoDTP), and sulfurized oxymolybdenum clithiocarbamate (MoDTC).

### (Rust Inhibitor)

Examples of the rust inhibitor include a fatty acid, an alkenyl succinic acid half ester, a fatty acid soap, an alkyl sulfonate, a polyhydric alcohol fatty acid ester, a fatty acid amine, an oxidized paraffin, and an alkyl polyoxyethylene ether.

### (Metal Deactivator)

Examples of the metal deactivator include a benzotriazole-based compound, a tolyltriazole-based compound, a thiadiazole-based compound, an imidazole-based compound, and a pyrimidine-based compound.

The lubricating oil composition of the present invention is constituted such that it contains the base oil and the aforementioned comb polymer having a specified molecular weight and further arbitrarily contains the aforementioned various additives for lubricating oil. As a more specific constitution, there is exemplified a lubricating oil composition composed of the base oil, the comb polymer, and additives containing a phenol-based antioxidant, an aliphatic amide, and a fluorinated silicone.

### [Various Physical Properties of Lubricating Oil Composition]

A kinematic viscosity at 40° C. of the lubricating oil composition according to one embodiment of the present invention is preferably 5 mm²/s or more and 35 mm²/s or less, more preferably 6 mm²/s or more and 30 mm²/s or less, and still more preferably 7.5 mm²/s or more and 20 mm²/s or less.

When the kinematic viscosity at 40° C. is 5 mm²/s or more and 35 mm²/s or less, the shock absorber is able to exhibit excellent damping characteristics.

A kinematic viscosity at 100° C. of the lubricating oil composition according to one embodiment of the present invention is preferably 2 mm²/s or more and 20 mm²/s or less, more preferably 3 mm²/s or more and 15 mm²/s or less, and still more preferably 4 mm²/s or more and 10 mm²/s or less.

Furthermore, a viscosity index of the lubricating oil composition according to one embodiment of the present invention is preferably 380 or more. When the viscosity index is 380 or more, a damping force of the shock absorber relative to the temperature change can be kept substantially constant.

Here, the damping force F of the shock absorber is in general determined according to the following formula (1).

F=A(αμv+βρv²) (1)

In the expression, A represents a constant inherent in the shock absorber; α and β each represent a constant inherent in the lubricating oil; μ represents a viscosity of the lubricating oil; ρ represents a density of the lubricating oil; and v represents a velocity of the piston.

According to the foregoing formula (1), as a difference in the viscosity of the lubricating oil at a temperature t1 and a temperature t2 is larger, a difference in the damping force at the respective temperatures [F(t1)−F(t2)] becomes larger. Therefore, as the viscosity index of the lubricating oil is larger, the difference in the viscosity of the lubricating oil at the respective temperature becomes smaller, and [F(t1)−F(t2)] becomes also smaller (a fluctuation in the damping force relative to the temperature change becomes smaller).

From this viewpoint, the viscosity index of the lubricating oil composition is more preferably 450 or more, still more preferably 600 or more, and especially preferably 700 or more. An upper limit of the viscosity index is about 900.

### [Application of Lubricating Oil Composition]

The lubricating oil composition for shock absorber of the present invention is used as a shock absorber fluid to be filled in shock absorbers of bodies of two-wheeled vehicles or four-wheeled vehicles, etc.

Namely, the lubricating oil composition of the present invention is suitable as the lubricating oil composition for shock absorber.

More specifically, the lubricating oil composition for shock absorber is usable for all of double cylinder type shock absorbers and single cylinder type shock absorbers of two-wheeled vehicles or four-wheeled vehicles, and in particular, it is suitably used for two-wheeled vehicles.

### [Damping Method and Shock Absorber]

For the purpose of relieving, for example, vibrations to be caused due to roughness of a road surface or sways generated on the occasion of sudden acceleration or sudden braking at the time of running of the vehicle body, the damping method of the present invention is a method for damping the foregoing vibrations, sways or the like by the shock absorber, etc., and the aforementioned lubricating oil composition for shock absorber of the present invention is one to be filled in this shock absorber, etc.

Examples of the shock absorber include a double cylinder type shock absorber and a single cylinder type shock absorber.

Though the aforementioned damping method may exhibit excellent damping force characteristics for shock absorbers of all of two-wheeled vehicles and four-wheeled vehicles, in particular, it is excellent in the damping force characteristics of a shock absorber for two-wheeled vehicle.

### [Production Method of Lubricating Oil Composition for Shock Absorber]

Though the production method of a lubricating oil composition for shock absorber of the present invention is not particularly limited, it is preferably a method including the following step (1).

Step (1): A step of blending the base oil with the aforementioned comb polymer.

Details of the base oil and the comb polymer that are used in the step (1) (suitable components, contents, content ratios to other components, etc.) are those described above.

In the present step (1), the aforementioned additives for lubricating oil may be further blended.

Details of these components (suitable components, contents, content ratios, etc.) are those described above.

Specifically, it is preferred that after blending the additive for lubricating oil in the base oil containing the aforementioned mineral oil or synthetic oil, the polymer solution having the aforementioned comb polymer dissolved therein is uniformly dispersed in the base oil with stirring by a known method.

From the viewpoint of uniformly dispersing the additive for lubricating oil, it is more preferred that after subjecting the base oil to temperature rise to 40 to 70° C., the additive for lubricating oil is blended and uniformly dispersed with stirring.

Lubricating oil compositions obtained in a way in which on the way or after the present step (1), parts of the polymer or other components, etc. are modified, or the two components react with each other to produce another component are also corresponding to the lubricating oil composition obtained by the production method of a lubricating oil composition for shock absorber of the present invention and fall within the technical scope of the present invention.

### EXAMPLES

Next, the present invention is described in more detail by reference to Examples, but it should be construed that the present invention is by no means limited by the following Examples. The measurement methods and evaluation methods of various physical properties are as follows.

### <Measurement Method of Molecular Weight of Polymer>

The mass average molecular weight (Mw) of the corn polymer, etc. was measured using a gel permeation chromatography device (“1260 Type HPLC”, manufactured by Agilent) under the following conditions, and the values measured as expressed in terms of a standard polystyrene conversion were adopted.

### (Measurement Conditions)

Column: Two “Shodex LF404” columns
Column temperature: 35° C.
Developing solvent: Chloroform
Flow rate: 0.3 mL/min

### <Measurement Methods of Various Physical Properties of Base Oil or Lubricating Oil Composition>

### (1) Kinetic Viscosities at 40° C. and 100° C.

The measurement was performed in conformity with JIS K2283:2000.

### (2) Viscosity Index

The measurement was performed in conformity with JIS K2283:2000.

In the following, only ones which were possible for measurement regarding the kinematic viscosity at 100° C. and ones which were possible for calculation regarding the viscosity index are shown.

### Examples 1 to 7 and Comparative Examples 1 to 3

Various synthetic oils and mineral oils were prepared according to the kinds and blending amounts shown in Table 1, thereby obtaining base oils (i) to (x); these were subjected to temperature rise to 45±5° C.; respective additives for lubricating oil were then added according to the kinds and blending amounts shown in Table 1; and the contents were uniformly mixed with stirring, thereby preparing lubricating oil compositions (I) to (X).

The synthetic oils, mineral oils, and polymers described in Table 1, which were used in the Examples and Comparative Examples, are as follows.

### <Synthetic Oil>

Synthetic oil A: Isoparaffin, kinematic viscosity at 40° C.=2.6 mm²/s.
Synthetic oil B: Poly-α-olefin, kinematic viscosity at 40° C.=5.1 mm²/s, kinematic viscosity at 100° C.=1.8 mm²/s, viscosity index=128.
Mineral oil A: Paraffinic mineral oil, kinematic viscosity at 40° C.=1.6 mm²/s.
Mineral oil B: Paraffinic mineral oil, kinematic viscosity at 40° C.=2.2 mm²/s, kinematic viscosity at 100° C.=1.0 mm²/s, viscosity index=69.
Mineral oil C: Paraffinic mineral oil, kinematic viscosity at 40° C.=18.0 mm²/s, kinematic viscosity at 100° C.=4.1 mm²/s, viscosity index=128.
Mineral oil D: Paraffinic mineral oil, kinematic viscosity at 40° C.=4.3 mm²/s, kinematic viscosity at 100° C.=1.5 mm²/s, viscosity index=66.
Mineral oil E: Paraffinic mineral oil, kinematic viscosity at 40° C.=7.1 mm²/s, kinematic viscosity at 100° C.=2.2 mm²/s, viscosity index=109.
Mineral oil F: Paraffinic mineral oil, kinematic viscosity at 40° C.=17.8 mm²/s, kinematic viscosity at 100° C.=4.1 mm²/s, viscosity index=131.

### <Polymer Solution>

Comb polymer: Comb polymer (Mw=4.9×10⁵) having at least a structural unit derived from a macromonomer having an Mn of 500 or more, which was used as a polymer solution diluted with a mineral oil as a diluent so as to have a solid concentration of 21% by mass.
Polymer A: Polymethacrylate (Mw=1.4×10⁵), which was used as a polymer solution diluted with a mineral oil as a diluent so as to have a solid concentration of 53% by mass.
Polymer B: Polymethacrylate (Mw=4.5×10⁴), which was used as a polymer solution diluted with a mineral oil as a diluent so as to have a solid concentration of 66% by mass.

### <Other Additives>

As other additives, a phenol-based antioxidant, a fatty acid amide, a fluorinated silicone, and the like were used.

With respect to the base oils (i) to (x) prepared in the Examples and Comparative Examples, various physical properties values were measured on the basis of the aforementioned measurement methods. In addition, with respect to the prepared lubricating oil compositions (I) to (X), various physical properties values were measured on the basis of the aforementioned measurement methods.

These results are shown in Table 1.

TABLE 1

| | | | | | | | | | | Com- | Com- | Com- |
|---|---|---|---|---|---|---|---|---|---|---|---|---|
| | | | | | | | | | | parative | parative | parative |
| | | | Exam- | Exam- | Exam- | Exam- | Exam- | Exam- | Exam- | Exam- | Exam- | Exam- |
| | | | ple 1 | ple 2 | ple 3 | ple 4 | ple 5 | ple 6 | ple 7 | ple 1 | ple 2 | ple 3 |
| Lubricating oil composition | | | (I) | (II) | (III) | (IV) | (V) | (VI) | (VII) | (VIII) | (IX) | (X) |
| Base oil | Kind of base oil | | Base oil | Base oil | Base oil | Base oil | Base oil | Base oil | Base oil | Base oil | Base oil | Base oil |
| | | | (i) | (ii) | (iii) | (iv) | (v) | (vi) | (vii) | (viii) | (ix) | (x) |
| | Synthetic oil A | mass % | 79.75 | — | 77.10 | 45.20 | 42.50 | 41.78 | — | — | — | — |
| | Synthetic oil B | mass % | — | 85.75 | — | 34.30 | 40.00 | 40.00 | — | — | — | — |
| | Mineral oil A | mass % | — | — | — | — | — | — | — | — | 35.00 | — |
| | Mineral oil B | mass % | — | — | — | — | — | — | — | 20.00 | — | — |
| | Mineral oil C | mass % | — | — | — | — | — | — | — | — | — | 81.75 |
| | Mineral oil D | mass % | — | — | — | — | — | — | — | 61.75 | — | — |
| | Mineral oil E | mass % | — | — | — | — | — | — | — | — | 40.80 | — |
| | Mineral oil F | mass % | — | — | — | — | — | — | 77.78 | — | — | — |
| Polymer | Comb polymer | mass % | 18.00 | 12.00 | 18.00 | 15.60 | 16.00 | 16.00 | 20.00 | — | — | — |
| solution | Polymer A | mass % | — | — | — | — | — | — | — | 4.00 | 3.00 | 4.00 |
| | Polymer B | mass % | — | — | — | — | — | — | — | 12.00 | 16.00 | 12.00 |
| Other additives | | mass % | 2.25 | 2.25 | 4.90 | 4.90 | 1.50 | 2.22 | 2.22 | 2.25 | 5.20 | 2.25 |
| Total | | mass % | 100.00 | 100.00 | 100.00 | 100.00 | 100.00 | 100.00 | 100.00 | 100.00 | 100.00 | 100.00 |
| Properties | Kinematic viscosity at | mm²/s | 2.6 | 5.1 | 2.6 | 3.4 | 3.5 | 3.5 | 17.8 | 3.6 | 3.2 | 18.0 |
| of base oil | 40° C. | | | | | | | | | | | |
| | Kinematic viscosity at | mm²/s | — | 1.8 | — | — | — | — | 4.1 | 1.4 | — | 4.1 |
| | 100° C. | | | | | | | | | | | |
| | Viscosity index | — | — | 128 | — | — | — | — | 131 | 79 | — | 128 |
| Properties | Resin component | mass % | 3.78 | 2.52 | 3.78 | 3.28 | 3.36 | 3.36 | 4.20 | 10.0 | 12.2 | 10.0 |
| of lubricating | Kinematic viscosity at | mm²/s | 9.1 | 8.0 | 10.6 | 9.5 | 7.6 | 8.5 | 25.0 | 12.4 | 14.2 | 39.9 |
| oil composition | 40° C. | | | | | | | | | | | |
| | Kinematic viscosity at | mm²/s | 5.1 | 3.9 | 5.6 | 5.1 | 4.5 | 4.8 | 9.4 | 4.7 | 5.3 | 9.5 |
| | 100° C. | | | | | | | | | | | |
| | Viscosity index | — | 687 | 557 | 633 | 646 | 775 | 705 | 398 | 365 | 371 | 234 |

The lubricating oil compositions (I) to (VII) prepared in the Examples exhibited a considerably high viscosity index as compared with the lubricating oil compositions (VIII) to (X) prepared in the Comparative Examples.

For that reason, it may be considered that the lubricating oil compositions of these Examples are a lubricating oil composition which, for example, in the case of being used for shock absorbers of bodies of two-wheeled vehicles, etc., is able to keep a damping force substantially constant and to exhibit excellent damping force characteristics even when the oil temperature largely varies.

1. A lubricating oil composition for shock absorber, the lubricating oil composition comprising a base oil and a comb polymer having a mass average molecular weight of 5×10⁴ or more and 1×10⁶ or less.

2. The lubricating oil composition for shock absorber according to claim 1, wherein a content of the comb polymer in terms of a resin component is 1% by mass or more and 10% by mass or less on the basis of a whole amount of the composition.

3. The lubricating oil composition for shock absorber according to claim 1, wherein a mass average molecular weight of the comb polymer is 3×10⁵ or more and 8×10⁵ or less.

4. The lubricating oil composition for shock absorber according to claim 1, wherein a kinematic viscosity at 40° C. of the base oil is 1 mm²/s or more and 8 mm²/s or less.

5. The lubricating oil composition for shock absorber according to claim 1, which has a kinematic viscosity at 40° C. of 5 mm²/s or more and 35 mm²/s or less.

6. The lubricating oil composition for shock absorber according to claim 1, which has a viscosity index of 380 or more.

7. The lubricating oil composition for shock absorber according to claim 1, which is adapted to function as a lubricating oil composition for a shock absorber of a two-wheeled vehicle.

8. A shock absorber, comprising the lubricating oil composition for shock absorber according to claim 1.

9. A method of damping sways or vibrations, the method comprising lubricating a shock absorber with the lubricating oil composition according to claim 1.

10. A method of producing a lubricating oil composition for shock absorber, the method comprising blending a base oil with a comb polymer having a mass average molecular weight of 5×10⁴ or more and 1×10⁶ or less, to obtain a lubricating oil composition.
